(19) United States
(12) Patent Application Publication
(10) Pub. No.: US 2022/0317359 A1
(43) Pub. Date: Oct. 6, 2022

(54) LIGHT SOURCE MODULE, METHOD OF MANUFACTURING LIGHT SOURCE MODULE, AND DISPLAY MODULE

(71) Applicants: BEIJING BOE DISPLAY TECHNOLOGY CO., LTD., Beijing (CN); BOE TECHNOLOGY GROUP CO., LTD., Beijing (CN)

(72) Inventors: Chaoyue Zhao, Beijing (CN); Peng Zhong, Beijing (CN); Tingxiu Hou, Beijing (CN); Jian Zhao, Beijing (CN); Yongkang Xiao, Beijing (CN); Lingyu Sun, Beijing (CN); Fei Liang, Beijing (CN); Jingjun Du, Beijing (CN); Xiuyun Chen, Beijing (CN)

(21) Appl. No.: 17/310,397

(22) PCT Filed: Oct. 23, 2020
(86) PCT No.: PCT/CN2020/123249

§ 371 Date: Jul. 30, 2021

(51) Int. Cl. F21V 8/00

(52) U.S. Cl. CPC G02B 6/0038; G02B 6/0093; G02B 6/0036; G02B 6/0065

(57) ABSTRACT

The present disclosure provides a light source module, a method of manufacturing a light source module, and a display module. The light source module includes: a light source; a light guide structure including a light incident surface; an optical control layer including a first surface away from the light guide structure and a second surface facing the light guide structure; and at least two optical structures arranged in the optical control layer and configured to adjust a light incident on the optical structures. Each optical structure includes a groove located in the optical control layer and a low refractive index material portion filled in the groove, and the low refractive index material portion has a refractive index less than that of the optical control layer body; and each optical structure includes a first optical surface and a second optical surface.

### CROSS REFERENCE TO RELATED APPLICATION(S)

This application is a Section 371 National Stage Application of International Application No. PCT/CN2020/123249, filed on Oct. 23, 2020, which is incorporated by reference herein in its entirety.

### TECHNICAL FIELD

The present disclosure relates to a field of display technology, and in particular to a light source module, a method of manufacturing a light source module, and a display module.

### BACKGROUND

Compared with transmissive display devices, a reflective display device has softer images and lower power consumption, and may achieve a better display effect, for example, in outdoors. Therefore, the reflective display device is more and more popular in e-reader, public display and other fields.

The reflective display device is greatly affected by external environment light. When the external environment light is insufficient, the display effect may be reduced.

### SUMMARY

In one aspect, there is provided a light source module, including:

a light source;

a light guide structure including a light incident surface and a first surface, wherein a light emitted by the light source enters the light guide structure through the light incident surface;

an optical control layer arranged on the first surface of the light guide structure, wherein the optical control layer includes an optical control layer body, and the optical control layer includes a first surface away from the light guide structure and a second surface facing the light guide structure; and

at least two optical structures arranged in the optical control layer and configured to adjust a light incident on the optical structure,

wherein the plurality of optical structures are arranged at intervals at least in a first direction perpendicular to the light incident surface;

wherein each optical structure includes a groove located in the optical control layer, and the groove forms an opening in the first surface of the optical control layer;

wherein each optical structure includes a first optical surface and a second optical surface, the first optical surface and the second optical surface are spaced apart from the second surface of the optical control layer, the first optical surface is arranged closer to the light incident surface than the second optical surface, the first optical surface is inclined with respect to the first surface of the optical control layer, the second optical surface is inclined with respect to the first surface of the optical control layer, and the first optical surface and the second optical surface are arranged gradually closer to each other in a direction toward the light guide structure; and

wherein the groove is filled with a low refractive index material portion having a refractive index less than that of the optical control layer body; or the groove is filled with air, and the refractive index of the optical control layer body is greater than that of air.

According to some exemplary embodiments, each optical structure includes a first included angle formed between the first optical surface and a surface where the first surface of the optical control layer is located and a second included angle formed between the first optical surface and the second optical surface, and the first included angle and the second included angle are designed such that at least a part of the light emitted from the light source propagates toward the light guide structure.

According to some exemplary embodiments, the refractive index of the light guide structure is substantially equal to that of the optical control layer body.

According to some exemplary embodiments, an orthographic projection of each optical structure on a plane defined by the first direction and a second direction perpendicular to the first surface of the optical control layer is a triangle.

According to some exemplary embodiments, the light source module includes at least a first distribution area and a second distribution area, and the first distribution area is closer to the light incident surface than the second distribution area; each optical structure has a depth equal to a size of the each optical structure in the second direction; an optical structure located in the first distribution area has a depth less than that of an optical structure located in the second distribution area.

According to some exemplary embodiments, the light source module includes at least a first distribution area and a second distribution area, and the first distribution area is closer to the light incident surface than the second distribution area; the optical structures have a first pitch equal to a distance between two adjacent optical structures in the first direction; and the optical structures located in the first distribution area have a first pitch greater than that of the optical structures located in the second distribution area.

According to some exemplary embodiments, the first included angle ranges from 40° to 50°, and/or the second included angle ranges from 48° to 58°.

According to some exemplary embodiments, the plurality of optical structures are arranged at intervals at least in a third direction, the second direction is perpendicular to the first surface of the optical control layer, and the third direction is perpendicular to the first direction and the second direction.

According to some exemplary embodiments, the optical structures have a second pitch equal to a distance between two adjacent optical structures in the third direction; and the optical structures located in the first distribution area have a second pitch greater than that of the optical structures located in the second distribution area.

According to some exemplary embodiments, the light source module further includes:

a protection structure arranged on a side of the optical control layer away from the light guide structure; and

an adhesive arranged between the optical control layer and the protection structure,

wherein an orthographic projection of the adhesive on the light guide structure covers orthographic projections of the plurality of optical structures on the light guide structure.

According to some exemplary embodiments, a refractive index of the protection structure, a refractive index of the adhesive and a refractive index of the optical control layer body are substantially equal to each other.

According to some exemplary embodiments, the light source module further includes a third distribution area arranged between the first distribution area and the second distribution area; an optical structure located in the first distribution area has a depth less than that of an optical structure located in the third distribution area, and the depth of the optical structure located in the third distribution area is less than that of an optical structure located in the second distribution area; and/or the optical structures located in the first distribution area have a first pitch greater than that of the optical structures located in the third distribution area, and the first pitch of the optical structures located in the third distribution area is greater than that of the optical structures located in the second distribution area.

According to some exemplary embodiments, the refractive index of the light control layer body ranges from 1.55 to 1.65.

According to some exemplary embodiments, each optical structure has a shape selected from a prism, a pyramid, a truncated pyramid and a truncated cone.

In another aspect, there is provided a display module including the light source module described above.

According to some exemplary embodiments, the display module further includes a display panel arranged on a side of the light guide structure away from the optical control layer, and the display panel is a reflective display panel.

In another aspect, there is provided a method of manufacturing a light source module, at least including:

preparing a roller with a raised structure, wherein the raised structure of the roller has a shape same as that of an optical structure to be formed;

applying an optical control layer material on a substrate, and making a groove in the optical control layer by using the roller, wherein the groove has a shape same as that of the optical structure to be formed; and

providing an adhesive layer on the optical control layer formed with the groove, so as to form an optical structure,

wherein the optical structure includes the groove located in the optical control layer and a low refractive index material portion filled in the groove, the optical control layer includes an optical control layer body, and the low refractive index material portion has a refractive index less than that of the optical control layer body;

wherein the optical control layer includes a first surface and a second surface, and the groove is formed in the first surface; and

wherein the optical structure includes a first optical surface inclined with respect to the first surface and a second optical surface inclined with respect to the first surface, and the first optical surface and the second optical surface are arranged gradually closer to each other in a direction toward the second surface.

### BRIEF DESCRIPTION OF THE DRAWINGS

With following description of the present disclosure with reference to the drawings, other objectives and advantages of the present disclosure would be obvious and the present disclosure would be understood comprehensively.

FIG. 1 shows a cross-sectional view of a light source module according to some exemplary embodiments of the present disclosure.

FIG. 2 shows a schematic plan view of an optical control layer and an optical structure included in a light source module according to some exemplary embodiments of the present disclosure.

FIG. 3 shows a light path diagram of a light source module according to some exemplary embodiments of the present disclosure.

FIG. 4 shows a schematic diagram of an optical structure included in a light source module according to some exemplary embodiments of the present disclosure, in which some light paths are schematically shown.

FIG. 5 shows a schematic diagram of a display module according to some exemplary embodiments of the present disclosure.

FIG. 6 shows a light path diagram of a display module according to some exemplary embodiments of the present disclosure.

FIG. 7 shows a schematic diagram of a light source module according to some exemplary embodiments of the present disclosure, in which a depth distribution of an optical structure is schematically shown.

FIG. 8 shows an enlarged view of the depth distribution of the optical structure shown in FIG. 7.

FIG. 9 shows a schematic diagram of a light source module according to some exemplary embodiments of the present disclosure, in which a pitch distribution of optical structures is schematically shown.

FIG. 10 shows an enlarged view of the pitch distribution of the optical structures shown in FIG. 9.

FIG. 11 shows a schematic diagram of a light source module according to some exemplary embodiments of the present disclosure, in which a depth distribution and a pitch distribution of the optical structures are schematically shown.

FIG. 12 shows a schematic diagram of a two-dimensional distribution of an optical structure of a light source module according to some exemplary embodiments of the present disclosure.

FIG. 13A to FIG. 13D respectively show schematic diagrams of appearance of the optical structure in a case of the two-dimensional distribution shown in FIG. 12.

FIG. 14 shows a flowchart of a method of manufacturing a light source module according to some embodiments of the present disclosure.

It should be noted that for the sake of clarity, in the drawings used to describe the embodiments of the present disclosure, sizes of layers, structures or areas may be enlarged or reduced, that is, these drawings are not drawn according to actual scale.

### DETAILED DESCRIPTION OF EMBODIMENTS

The technical solutions of the present disclosure will be further described in detail below through the embodiments and in conjunction with the drawings. In the specification, the same or similar reference numerals indicate the same or similar components. The following description of the embodiments of the present disclosure with reference to the drawings is intended to explain a general inventive concept of the present disclosure, and should not be understood as a limitation of the present disclosure.

In addition, in the following detailed description, for the convenience of explanation, many specific details are set forth to provide a comprehensive understanding of the embodiments of the present disclosure. Obviously, however, one or more embodiments may also be implemented without these specific details.

It should be understood that, although terms “first,” “second” and so on may be used herein to describe different elements, these elements should not be limited by these terms. These terms are only used to distinguish one element from another. For example, without departing from the scope of the exemplary embodiments, a first element may be named as a second element, and similarly, the second element may be named as the first element. A term “and/or” as used here includes any and all combinations of one or more related listed items.

It should be understood that when an element or layer is referred to as being “formed on” another element or layer, the element or layer may be directly or indirectly formed on the other element or layer. That is, for example, an intermediate element or an intermediate layer may be present. In contrast, when an element or layer is referred to as being “directly formed on” another element or layer, no intermediate elements or layers are present. Other terms used to describe a relationship between elements or layers (for example, “between” and “directly between”, “adjacent to” and “directly adjacent to”, etc.) should be interpreted in a similar manner.

Herein, directional expressions “first direction”, “second direction” and “third direction” are used to describe different directions along the light source module or the display module. It should be understood that such expressions are only exemplary descriptions, and are not limitations to the present disclosure.

Some exemplary embodiments of the present disclosure provide a light source module, including: a light source; a light guide structure including a light incident surface and a first surface, wherein a light emitted by the light source enters the light guide structure through the light incident surface; an optical control layer arranged on the first surface of the light guide structure, wherein the optical control layer includes an optical control layer body, and the optical control layer includes a first surface away from the light guide structure and a second surface facing the light guide structure; and at least two optical structures arranged in the optical control layer and configured to adjust a light incident on the optical structure, wherein the plurality of optical structures are arranged at intervals at least in a first direction perpendicular to the light incident surface; wherein each optical structure includes a groove located in the optical control layer and a low refractive index material portion filled in the groove, the groove is arranged to form an opening in the first surface of the optical control layer, and the low refractive index material portion has a refractive index less than that of the optical control layer body; and wherein each optical structure includes a first optical surface and a second optical surface, the first optical surface and the second optical surface are spaced apart from the second surface of the optical control layer, the first optical surface is arranged closer to the light incident surface than the second optical surface, the first optical surface is inclined with respect to the first surface of the optical control layer, the second optical surface is inclined with respect to the first surface of the optical control layer, and the first optical surface and the second optical surface are arranged gradually closer to each other in a direction toward the light guide structure. In the embodiments of the present disclosure, the light emitted from the light source is adjusted by the optical structure, so that the light emitted from the light source and incident on a component below (such as a display panel) is increased.

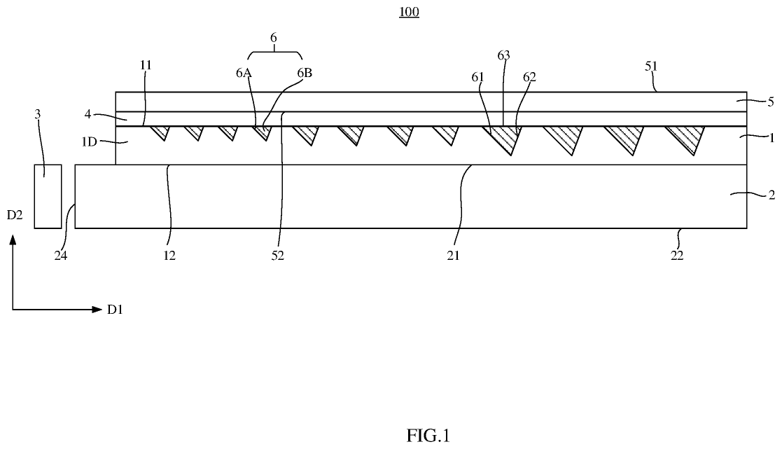

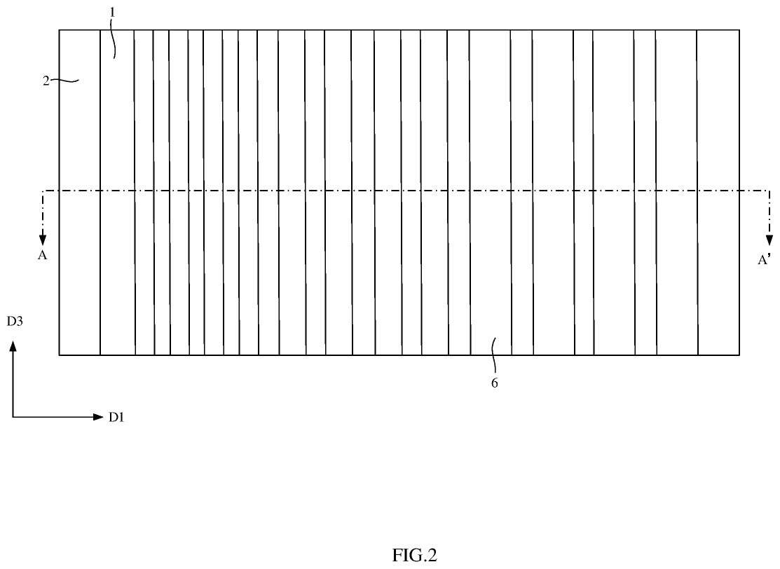

FIG. 1 shows a cross-sectional view of a light source module according to some exemplary embodiments of the present disclosure. FIG. 2 shows a schematic plan view of an optical control layer and an optical structure included in a light source module according to some exemplary embodiments of the present disclosure. Referring to FIG. 1 and FIG. 2, a light source module 100 according to the embodiments of the present disclosure may include a light source 3, a light guide structure 2, an optical control layer 1, an adhesive 4, and a protection structure 5.

As shown in FIG. 1 and FIG. 2, the light source 3 may be arranged on a side of the light guide structure 2, for example, on a left side in FIG. 1 and FIG. 2. The light guide structure 2 may be formed as a light guide layer or a light guide plate. The light guide structure 2 may include a first surface 21, a second surface 22 and a light incident surface 24. The second surface 22 is arranged opposite to the first surface 21, and the light incident surface 24 is connected to the first surface 21 and the second surface 22. The light source 3 is arranged opposite to the light incident surface 24. The light emitted by the light source 3 enters the light guide structure 2 through the light incident surface 24 and exits from the first surface 21 and the second surface 22.

For example, the first surface 21 may be a surface of the light guide structure 2 on a side close to the optical control layer 1, that is, an upper surface in FIG. 2; the second surface 22 may be a surface of the light guide structure 2 on a side close to a display panel (to be described below), that is, a lower surface in FIG. 2. The first surface 21 and the second surface 22 may be substantially parallel to each other.

Herein, a line perpendicular to a surface is called a normal line of the surface. Referring to FIG. 2, a first direction D1 is parallel to a normal line of the light incident surface 24, and a second direction D2 is parallel to a normal line of the first surface 21 or a normal line of the second surface 22. Referring to FIG. 1, a third direction D3 is perpendicular to both the first direction D1 and the second direction D2.

For example, the light guide structure 2, the optical control layer 1, the adhesive 4 and the protection structure 5 may be stacked in the second direction D2.

For example, the light source 3 may include a light emitting diode (LED) or a light bar including a plurality of light emitting diodes, but the embodiments of the present disclosure are not limited thereto. In other embodiments, the light source 3 may also include an organic light emitting diode, a quantum dot light emitting diode, a micro light emitting diode, a mini light emitting diode, and other components suitable for light emission.

Continuing to refer to FIG. 2, the optical control layer 1 is arranged on the first surface 21. The optical control layer 1 may include an optical control layer body 1D and a plurality of optical structures 6. The optical structure 6 is arranged on a side of the optical control layer body 1D away from the light guide structure 2 or the first surface 21.

The optical control layer 1 includes a first surface 11 away from the light guide structure 2 and a second surface 12 facing the light guide structure 2. For example, the second surface 12 may be in contact with the first surface 21 of the light guide structure 2.

For example, in some embodiments, the optical structure 6 includes a groove 6A. The groove 6A is recessed from the first surface 11 of the optical control layer toward the second surface 12 of the optical control layer, and is formed as a groove located in the optical control layer 1 and having a predetermined depth. That is, the groove 6A forms an opening at the first surface 11 of the optical control layer, or in other words, the groove 6A opens at the first surface 11 of the optical control layer.

Referring to FIG. 1 and FIG. 2 in combination, a plurality of grooves 6A are arranged at intervals in the first direction D1. For example, each groove 6A may extend in the third direction D3, and an extension length of the groove 6A in the third direction D3 may be less than a length of the optical control layer 1 in the third direction D3. In this case, at least two grooves 6A may be arranged at intervals in the third direction D3. Further, each groove 6A may penetrate the optical control layer 1 in the third direction D3.

For example, in some embodiments, the optical structure 6 may further include a low refractive index material portion 6B filled in the groove 6A. The low refractive index material portion 6B has a refractive index less than that of a material of the optical control layer body 1D.

For example, the groove 6A may contain air. That is, the optical structure 6 includes the groove 6A and air 6B contained in the groove 6A. The refractive index of the material of the optical control layer body 1D may be greater than that of air.

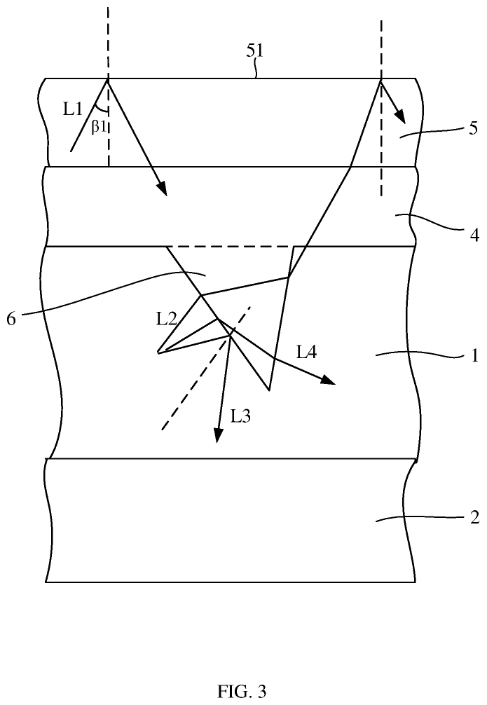

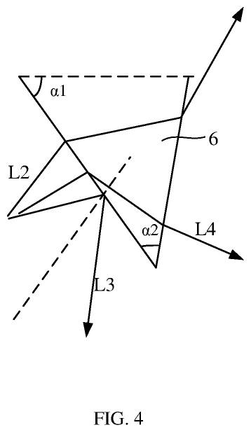

FIG. 3 shows a light path diagram of a light source module according to some exemplary embodiments of the present disclosure. FIG. 4 shows a schematic diagram of an optical structure included in a light source module according to some exemplary embodiments of the present disclosure, in which some light paths are schematically shown. FIG. 5 shows a schematic diagram of a display module according to some exemplary embodiments of the present disclosure.

Referring to FIG. 1 to FIG. 4 in combination, the optical structure 6 includes a first optical surface 61, a second optical surface 62 and a third optical surface 63. The first optical surface 61 is located on a side close to the light incident surface 24, and the second optical surface 62 is located on a side away from the light incident surface 24. That is, in one optical structure 6, the first optical surface 61 is arranged closer to the light incident surface 24 than the second optical surface 62. The third optical surface 63 connects the first optical surface 61 and the second optical surface 62. The third optical surface 63 may be arranged substantially parallel to the first surface 11 of the optical control layer.

It should be noted that in a case that the low refractive index material portion 6B is air, the third optical surface 63 is a virtual surface coplanar with the first surface 11 of the optical control layer.

For example, both the first optical surface 61 and the second optical surface 62 are spaced apart from the second surface 12 of the optical control layer, that is, spaced a distance from the second surface 12 of the optical control layer in the second direction D2. The third optical surface 62 is coplanar with the first surface 11 of the optical control layer.

In the embodiments of the present disclosure, a first included angle α1 is formed between the first optical surface 61 and the third optical surface 63, and a second included angle α2 is formed between the first optical surface 61 and the second optical surface 62. As shown in FIG. 2, the first optical surface 61 and the second optical surface 62 may be directly connected. Each groove 6A has a triangular cross section, that is, an orthographic projection of each groove 6A on a plane formed by the first direction D1 and the second direction D2 is a triangle.

In the embodiments of the present disclosure, the refractive index of the optical control layer body 1D may be greater than that of the low refractive index material portion or the air 6B. That is, the optical control layer body 1D may be formed of a high refractive index material, and the low refractive index material portion 6B may be formed of a low refractive index material. For example, the refractive index of the optical control layer body 1D may be between 1.55 and 1.65. The refractive index of the low refractive index material portion 6B may be between 1 and 1.2, and the refractive index of air may be about 1. For example, the optical control layer body 1D may be made of a material containing UV glue (that is, ultraviolet light curable optical glue). The optical control layer body 1D may have a thickness (a size in the second direction D2) of 15 μm to 30 μm.

For example, the light guide structure 2 may have a refractive index close to that of the optical control layer body 1D, that is, the light guide structure 2 and the optical control layer body 1D may have substantially the same refractive index. For example, the refractive index of the light guide structure 2 may be between 1.55 and 1.65. The light guide structure 2 may be made of a material containing polycarbonate (PC) or other transparent high-refractive-index light-guide materials. The light guide structure 2 may function as a light guide to guide the light emitted by the light source 3 into the light source module. In addition, the light guide structure 2 may further support various film layers. The light guide structure 2 may have a certain degree of bendability.

As shown in FIG. 2, the protection structure 5 of the light source module is arranged on a side of the optical control layer 1 away from the light guide structure 2, and is used to protect the optical structure 6, the optical control layer 1, the light guide structure 2 and other components below. The adhesive 4 is arranged between the optical control layer 1 and the protection structure 5 so as to bond the protection structure 5 and the optical control layer 1.

The protection structure 5 may have a refractive index close to that of the optical control layer body 1D, that is, the protection structure 5 and the optical control layer body 1D may have substantially the same refractive index. For example, the refractive index of the protection structure 5 may be between 1.55 and 1.65. The protection structure 5 may be made of a material containing polymethylmethacrylate (PMMA) or other transparent high-refractive-index materials. For example, the protection structure 5 may have a thickness (a size in the second direction D2) of 0.1 mm to 0.2 mm

The protection structure 5 includes a first protection surface 51 and a second protection surface 52. The first protection surface 51 is located on a side of the protection structure 5 away from the optical control layer 1, and the second protection surface 52 is located on a side of the protection structure 5 close to the optical control layer 1.

The adhesive 4 may have a refractive index close to that of the optical control layer body 1D, that is, the adhesive 4 and the optical control layer body 1D may have substantially the same refractive index. For example, the refractive index of the adhesive 4 may be between 1.55 and 1.65. The adhesive 4 may be made of a material containing UV glue. For example, the adhesive 4 may have a thickness (a size in the second direction D2) of about 2 μm.

Referring to FIG. 5, a display module 1000 according to some embodiments of the present disclosure may include the light source module 100 described above and a display panel 10. The display panel 10 may be a reflective display panel. The display panel 10 may be bonded to the light source module 100 through an adhesive layer 15. For example, the adhesive layer 15 may contain a pressure sensitive adhesive. The adhesive layer 15 may have a refractive index less than that of the light guide structure 2. The adhesive layer 15 may be a transparent adhesive layer.

The reflective display panel may be a reflective liquid crystal display panel, an electronic ink display panel, or an electrowetting-based reflective display panel, which is not particularly limited in the embodiments of the present disclosure. For example, the display panel 10 may include a liquid crystal cell and a display substrate with a reflective structure arranged on a side of the liquid crystal cell. Based on a liquid crystal display mode, specific examples of the liquid crystal cell may include a twisted or non-twisted liquid crystal cell, such as a TN (twisted nematic) liquid crystal cell, a STN (super twisted nematic) liquid crystal cell, a VA (vertical alignment) liquid crystal cell, etc.

The display panel 10 is located on the side of the light guide structure 2 away from the optical control layer 1. For the convenience of description, a side of the protection structure 5 away from the display panel 10 is referred to as a display side of the display module, and a side of the display panel 10 away from the protection structure 5 is referred to as a back side of the display module.

Hereinafter, a light path of the light emitted from the light guide structure 2 will be described with reference to FIG. 1 to FIG. 5.

For example, referring to a light ray L1 in FIG. 3, some light rays do not pass through the optical structure 6 but are directly incident on the first protection surface 51 of the protection structure 5. A critical angle at which a total reflection occurs at the first protection surface 51 is β0, which may be, for example, equal to about 41°. According to the total reflection formula, when an included angle β1 between the light ray and a normal direction at the first protection surface 51 is greater than the critical angle β0, the light ray L1 may be totally reflected at the first protection surface 51. After total reflection occurs, the light ray may continue to propagate in the light source module 100. A part of the light ray is directly incident on a surface of the display panel 10 through a gap between the optical structures 6, and the other part of the light ray is changed by the optical structure 6 and continues to propagate toward the display side.

For example, referring to a light ray L2 in FIG. 3, some light rays are incident on the optical structure 6 and refracted at both the first optical surface 61 and the second optical surface 62. After being refracted by these two optical surfaces, these light rays propagate toward the display side and are incident on the first protection surface 51 of the protection structure 5. When an included angle β1 between these light rays and the normal direction at the first protection surface 51 is greater than the critical angle β0, the light rays may be totally reflected at the first protection surface 51. Subsequently, propagation of the light ray is similar to that of the light ray L1.

For example, referring to a light ray L3 in FIG. 3, some light rays are incident on the optical structure 6 and are totally reflected at the first optical surface 61. For example, a critical angle at which a total reflection occurs at the first optical surface 61 is β10, which may be, for example, equal to about 39.3°. The light ray reflected by the first optical surface 61 propagates toward the back side and is incident on the display panel 10.

For example, referring to a light ray L4 in FIG. 3, some light rays are incident on the optical structure 6 and refracted at both the first optical surface 61 and the second optical surface 62. After being refracted by these two optical surfaces, these light rays propagate toward the back side and are incident on the display panel 10.

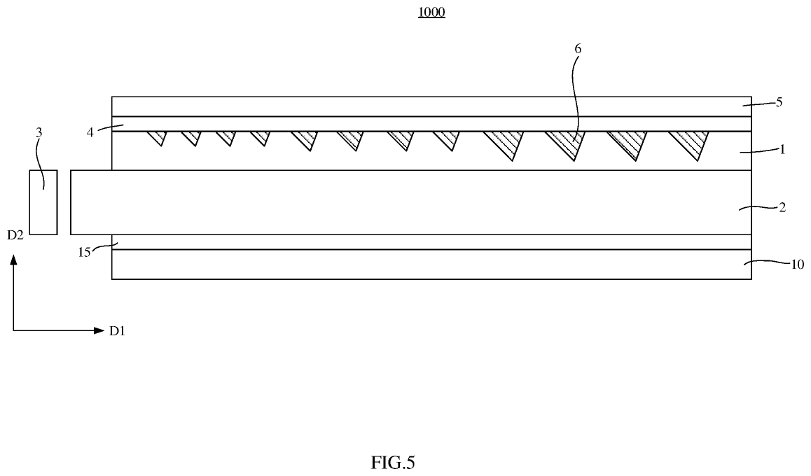

FIG. 6 shows a light path diagram of a display module according to some exemplary embodiments of the present disclosure. Referring to FIG. 1 to FIG. 6 in combination, the display panel 10 may be a reflective display panel. When the light rays mentioned are incident on the display panel 10, they may be reflected by the display panel 10, and thus propagate toward the display side.

For example, referring to a light ray L5 in FIG. 6, a part of the light ray is reflected by the display panel 10, propagates through the light guide structure 2, the optical control layer body 1D, the adhesive 4 and the protection structure 5, and directly exits from the protection structure 5 without passing through the optical structure 6.

For example, referring to a light ray L6 in FIG. 6, a part of the light ray is reflected by the display panel 10 and passes through the optical structure 6. These light rays may have an incident angle less than a total reflection angle at the first optical surface 61, so that they may also exit directly from the protection structure 5.

For example, referring to a light ray L7 in FIG. 6, a part of the light ray is reflected by the display panel 10 and passes through the optical structure 6. These light rays may have an incident angle greater than or equal to the total reflection angle at the first optical surface 61, so that they may be reflected by the optical structure 6. That is, these light rays may be adjusted by the optical structure 6 again, and the above process will be repeated until these light rays finally exit.

In the embodiments of the present disclosure, the light emitted from the light source 3 is adjusted by the optical structure 6, so that the light emitted from the light source 3 and incident on the display panel 10 below may be increased. In this way, brightness of the display panel 10 may be enhanced, and the display effect of the display module in a case of insufficient external environment light may be improved.

In the embodiments of the present disclosure, a luminous flux of the light emitted from the light source 3 and incident on the display panel 10 below is referred to as a first luminous flux, denoted by Q1; a luminous flux of the light emitted from the light source 3 and not incident on the display panel 10 below but directly exiting from the protection structure 5 is referred to as a second luminous flux, denoted by Q2. A luminous efficiency ratio is Q0=Q1/Q2, that is, the luminous efficiency ratio is a ratio of the first luminous flux to the second luminous flux. The greater the luminous efficiency ratio Q0, the more effectively the light emitted by the light source 3 is used, and the more beneficial it is to improve the brightness of the display module.

In the embodiments of the present disclosure, based on the structure shown in FIG. 1 to FIG. 6, the luminous efficiency ratio QO has a certain functional relationship with the first included angle α1 and the second included angle α2 in a case that the thickness and the refractive index of each component or film layer remain unchanged.

Following evaluation function may be established:

MF=Target−f(α1, α2),

where MF represents the evaluation function, Target represents a target value for luminous flux optimization, and f (α1, α2) represents a function with the first included angle α1 and the second included angle α2 as variables.

Monte Carlo tracing algorithm may be used to make the evaluation function MF approach 0 as much as possible, and then the target value Target for the luminous flux optimization reaches a maximum value, so that an optimal solution for the first included angle α1 and the second included angle α2 may be obtained. For example, an initial value may be firstly given to the target value Target. For example, an absolute value of the first luminous flux Q1 may be 2, and an absolute value of the second luminous flux Q2 may be 10, then a set of α1, α2 may be calculated. Next, the target value Target may be gradually changed (the first luminous flux Q1 increases and the second luminous flux Q2 decreases), and α1 and α2 are calculated respectively until there is no solution for α1 and α2. For example, in an exemplary embodiment, the optimal solution for the first included angle α1 and the second included angle α2 is:

α1=45° and α2=53°.

It should be understood that when the laminated structure of the display module and the refractive index of each film layer forming the laminated structure change, the optimal solution for the first included angle α1 and the second included angle α2 will change accordingly.

In the embodiments of the present disclosure, the first included angle α1 and the second included angle α2 may vary within a range of ±5° of the above optimal solution. For example, the first included angle α1 may range from 40° to 50°, and the second included angle α2 may range from 48° to 58°. Alternatively, the first included angle α1 and the second included angle α2 may vary within a range of ±2° of the above optimal solution. For example, the first included angle α1 may range from 43° to 57°, and the second included angle α2 may range from 51° to 55°. In this way, values of the first included angle α1 and the second included angle α2 may ensure a large light efficiency ratio Q, so that the brightness of the display module may be effectively improved.

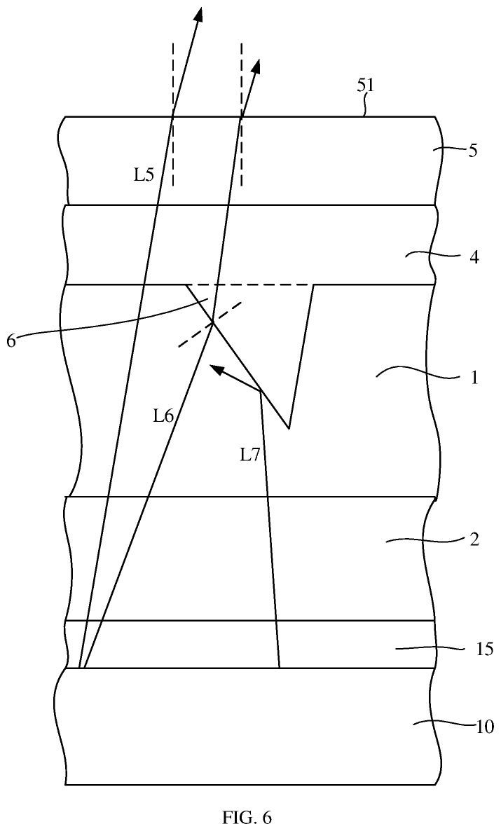

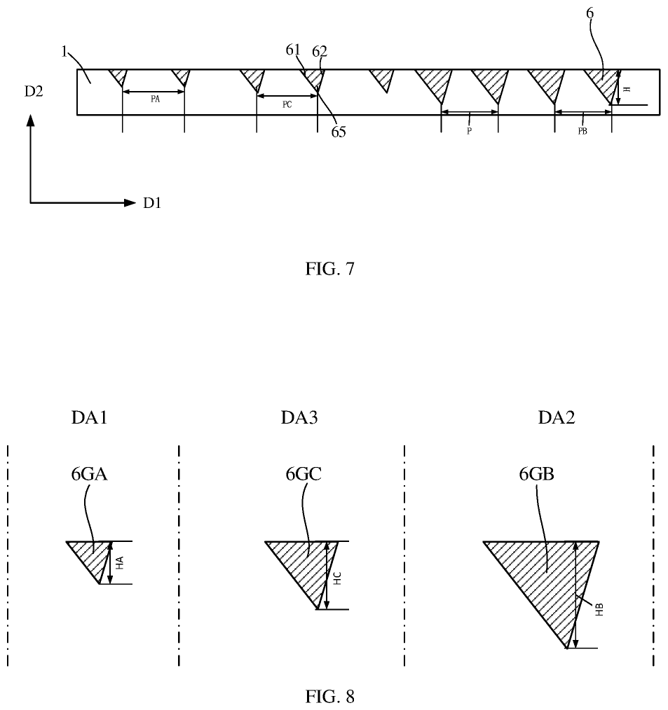

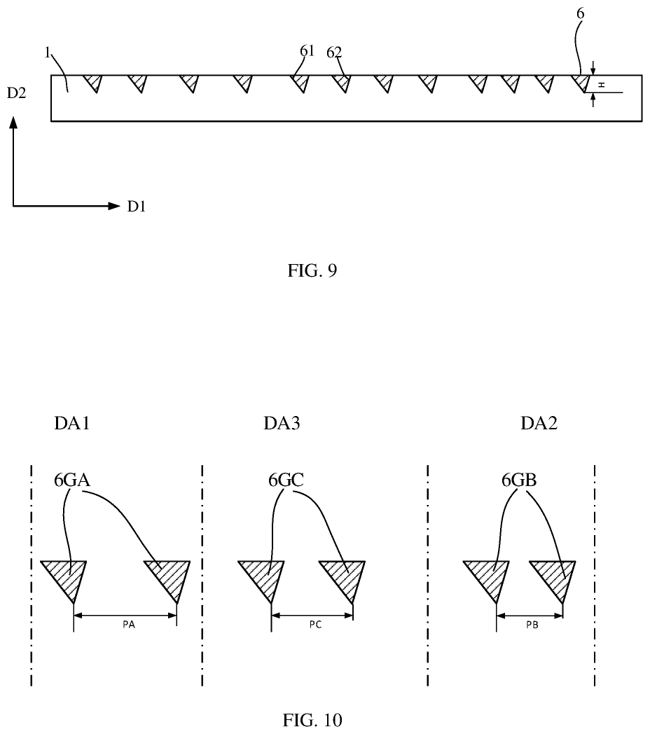

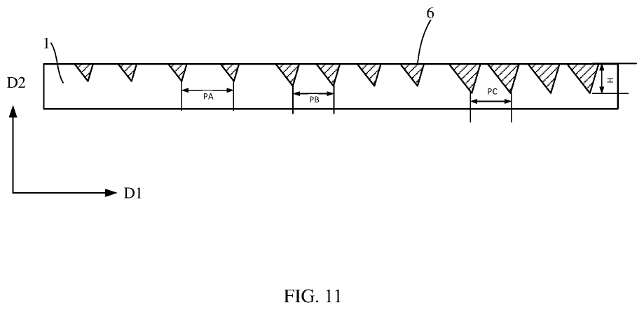

FIG. 7 shows a schematic diagram of a light source module according to some exemplary embodiments of the present disclosure, in which a depth distribution of an optical structure is schematically shown. FIG. 8 shows an enlarged view of the depth distribution of the optical structure shown in FIG. 7. FIG. 9 shows a schematic diagram of a light source module according to some exemplary embodiments of the present disclosure, in which a pitch distribution of the optical structures is schematically shown. FIG. 10 shows an enlarged view of the pitch distribution of the optical structures shown in FIG. 9. FIG. 11 shows a schematic diagram of a light source module according to some exemplary embodiments of the present disclosure, in which a depth distribution and a pitch distribution of the optical structures are schematically shown.

Referring to FIG. 1 to FIG. 11 in combination, in the embodiments of the present disclosure, a plurality of optical structures 6 are distributed at intervals in the first direction D1. Each optical structure 6 has a depth H, which is a size of the optical structure 6 in the second direction D2. A distance between two adjacent optical structures 6 is a pitch of the optical structures 6, denoted by P. For example, for an optical structure 6, the first optical surface 61 and the second optical surface 62 intersect at a line 65, which may be referred to as a top line. The pitch P may be equal to a distance between the top lines 65 of two adjacent optical structures 6 in the first direction D1.

For example, the light source module 100 may include a plurality of distribution areas. In FIGS. 7 and 8, three distribution areas DA1, DA2 and DA3 are schematically shown. The first distribution area DA1 is arranged close to the light incident surface 24, the second distribution area DA2 is arranged away from the light incident surface 24, and the third distribution area DA3 is located between the first distribution area DA1 and the second distribution area DA2.

It should be noted that, in the embodiments shown, the three distribution areas are schematically illustrative, and do not constitute a special limitation to the embodiments of the present disclosure. In other embodiments of the present disclosure, the light source module 100 may include less (e.g., two) or more (e.g., four, five or more) distribution areas.

At least one optical structure 6 is located in the first distribution area DA1, at least one optical structure 6 is located in the third distribution area DA3, and at least one optical structure 6 is located in the second distribution area DA2. For the convenience of description, the optical structure 6 located in the first distribution area DA1 is referred to as a first optical structure 6GA, the optical structure 6 located in the second distribution area DA2 is referred to as a second optical structure 6GB, and the optical structure 6 located in the third distribution area DA3 is referred to as a third optical structure 6GC. Accordingly, the depth of the first optical structure 6GA may be represented by HA, and the pitch may be represented by PA; the depth of the second optical structure 6GB may be represented by HB, and the pitch may be represented by PB; the depth of the third optical structure 6GC may be represented by HC, and the pitch may be represented by PC.

In some embodiments, a plurality of first optical structures 6GA may be provided in the first distribution area DA1, a plurality of second optical structures 6GB may be provided in the second distribution area DA2, and a plurality of third optical structures 6GC may be provided in the third distribution area DA3.

In an embodiment, the optical structures provided in each distribution area may have cross-sections of the same shape. For example, the first optical structure 6GA, the second optical structure 6GB and the third optical structure 6GC may all have a triangular cross section as shown in FIG. 4. The first included angles α1 in the first optical structure 6GA, the second optical structure 6GB and the third optical structure 6GC are equal to each other, and the second included angles α2 in the first optical structure 6GA, the second optical structure 6GB and the third optical structure 6GC are also equal to each other.

For example, the first optical structure 6GA provided in the first distribution area DA1 may have a triangular cross-section as shown in FIG. 4, and two vertex angles of the triangular cross-section (the first included angle α1 and second included angle α2 described above) may have a value in the range described above. The second optical structure 6GB provided in the second distribution area DA2 may have a triangular cross-section as shown in FIG. 4, and two vertex angles of the triangular cross-section (the first included angle α1 and second included angle α2 described above) may have a value in the range described above. The third optical structure 6GC provided in the third distribution area DA3 may have a triangular cross-section as shown in FIG. 4, and two vertex angles of the triangular cross-section (the first included angle α1 and second included angle α2 described above) may have a value in the range described above.

For example, the depths HA of the plurality of first optical structures 6GA are equal to each other, and the pitches PA of the plurality of first optical structures 6GA are equal to each other. The depths HB of the plurality of second optical structures 6GB are equal to each other, and the pitches PB of the plurality of second optical structures 6GB are equal to each other. The depths HC of the plurality of third optical structures 6GC are equal to each other, and the pitches PC of the plurality of third optical structures 6GC are equal to each other.

For example, in some embodiments of the present disclosure, the pitch PA of the first optical structures 6GA may be equal to the pitch PC of the third optical structures 6GC, and the pitch PC of the third optical structures 6GC may be equal to the pitch PB of the second optical structures 6GB.

In some embodiments of the present disclosure, the depth HA of the first optical structure 6GA is less than the depth HC of the third optical structure 6GC, and the depth HB of the third optical structure 6GC is less than the depth HB of the second optical structure 6GB.

In the embodiments of the present disclosure, because a total amount of the light on the side close to the light incident surface 24 is large, the depth of the optical structure located in the first distribution area DA1 is set to be small, so that a small proportion of light is extracted by the first optical structure 6GA. Because a total amount of the light on the side away from the light incident surface 24 is small, the depth of the optical structure located in the second distribution area DA2 is set to be large, so that a large proportion of light is extracted by the second optical structure 6GB. A case of the third distribution area DA3 is located between that of the first optical distribution area DA1 and the second distribution area DA2. In this way, the light may be evenly distributed in each distribution area of the display module, so that a uniformity of the display module may be improved.

Referring to FIG. 9 and FIG. 10 in combination, in some embodiments of the present disclosure, the optical structures provided in each distribution area may have cross-sections of the same shape. For example, the first optical structure 6GA, the second optical structure 6GB and the third optical structure 6GC may all have a triangular cross section as shown in FIG. 4. The triangular cross section of the first optical structure 6GA, the triangular cross section of the second optical structure 6GB and the triangular cross section of the third optical structure 6GC may have side lengths equal to each other, respectively. The first included angles α1 in the first optical structure 6GA, the second optical structure 6GB and the third optical structure 6GC are equal to each other, and the second included angles α2 in the first optical structure 6GA, the second optical structure 6GB and the third optical structure 6GC are also equal to each other. The pitch PA of the first optical structures 6GA may be greater than the pitch PC of the third optical structures 6GC, and the pitch PC of the third optical structures 6GC may be greater than the pitch PB of the second optical structures 6GB. That is, the optical structures 6 are distributed sparsely on the side close to the light incident surface 24 and densely distributed on the side away from the light incident surface 24. In other words, the optical structures 6 are arranged in a sparse to dense manner from the side close to the light incident surface 24 to the side away from the light incident surface 24.

For example, the depth HA of the first optical structure 6GA, the depth HB of the third optical structure 6GC and the depth HC of the second optical structure 6GB may be equal to each other.

For example, assuming that a total luminous flux is Q and the display module includes N distribution areas, a total luminous flux A extracted by each distribution area should be equal to Q/N. In one distribution area, the plurality of optical structures in a direction away from the light source may be referred to as a 1^{st} optical structure, a 2^{nd} optical structure, a 3^{rd} optical structure, and so on. The 1^{st} optical structure has a light extraction efficiency of c, and the 2^{nd} optical structure has a light extraction efficiency of d. In a case that each optical structure has substantially the same structure and the same size, each optical structure has substantially the same light extraction efficiency. The luminous flux extracted by the 1^{st} optical structure is A*c, the luminous flux extracted by the 2^{nd} optical structure is [A−(A*c)]*d, and so on. That is, the luminous flux that each optical structure may extract decreases in a direction away from the light incident surface 24. In the embodiments described above, the optical structures 6 are arranged in a sparse to dense manner from the side close to the light incident surface 24 to the side away away from the light incident surface 24. In this way, the light may be evenly distributed in the distribution areas of the display module, so that the uniformity of the display module may be improved.

For example, the optical structures in each distribution area may have different depths and pitches. Referring to FIG. 11, the depth HA of the first optical structure 6GA is less than the depth HC of the third optical structure 6GC, and the depth HC of the third optical structure 6GC is less than the depth HB of the second optical structure 6GB. Further, the pitch PA of the first optical structures 6GA may be greater than the pitch PC of the third optical structures 6GC, and the pitch PB of the third optical structures 6GC may be greater than the pitch PB of the second optical structures 6GB. In this way, the light may be evenly distributed in each distribution area of the display module, so that a uniformity of the display module may be improved.

In the specific design, a number of the distribution areas may be determined firstly according to the size of the display module, the process feasibility, and other factors. Next, the luminous flux distribution in each distribution area may be determined according to the total luminous flux and the number of the distribution areas. Then, the sizes (for example, the depths and pitches) of the optical structures in each distribution area may be determined according to the luminous flux distribution in each distribution area.

For example, in the embodiments of the present disclosure, the pitch of the optical structures in each distribution area may be greater than or equal to 30 microns and less than or equal to 300 microns. The inventor found through research that if the pitch of the optical structures is greater than 300 microns, the optical structures may be distributed sparsely, resulting in uneven brightness during display of the display module. If the pitch of the optical structures is less than 30 microns, it may cause difficulty in the processing technology and increase unevenness, which is not conducive to the function of a single optical structure.

For example, in an exemplary embodiment, the light source module 100 may include three distribution areas. The optical structures in each distribution area have the same pitch of, for example, 100 microns. The optical structure in the first distribution area may have a depth of about 4 microns, the optical structure in the second distribution area may have a depth of about 9 microns, and the optical structure in the third distribution area may have a depth of about 14 microns. In this embodiment, the uniformity of the display module may reach more than 60%.

For example, in the embodiments of the present disclosure, the light source module 100 may include two distribution areas, one is arranged close to the light incident surface 24, and the other is arranged away from the light incident surface 24. The depth of the optical structure 6 located in the distribution area close to the light incident surface 24 may be less than that of the optical structure 6 located in the distribution area away from the light incident surface 24, and/or the pitch of the optical structures 6 located in the distribution area close to the light incident surface 24 may be less than that of the optical structure 6 located in the distribution area away from the light incident surface 24.

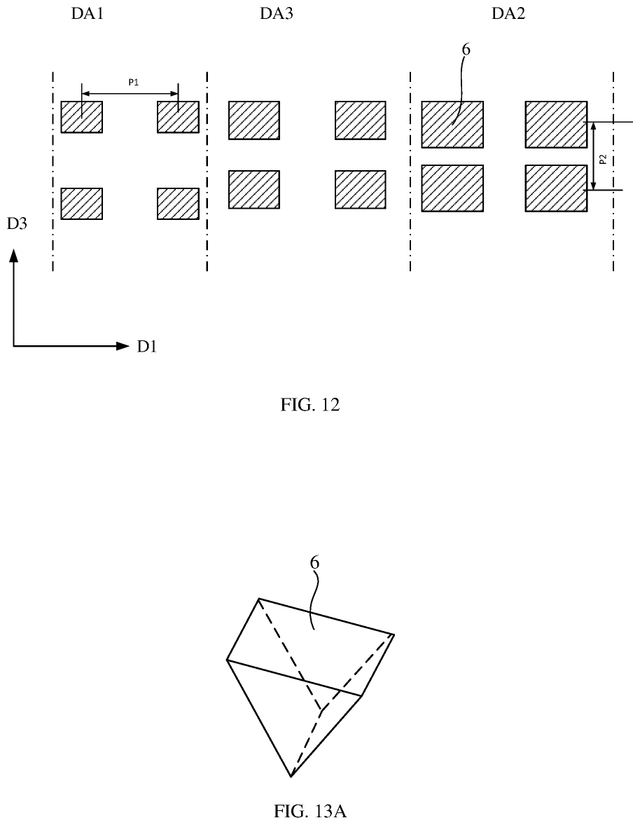

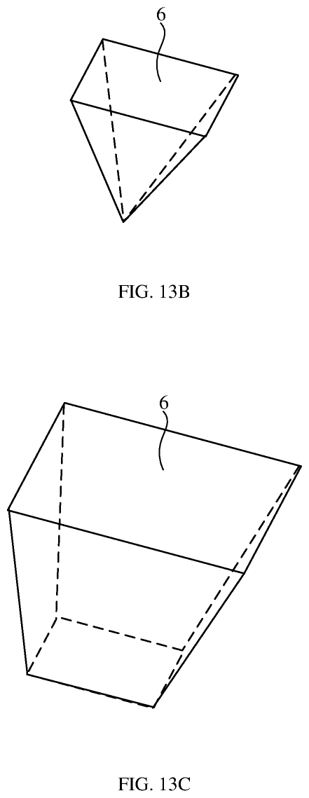

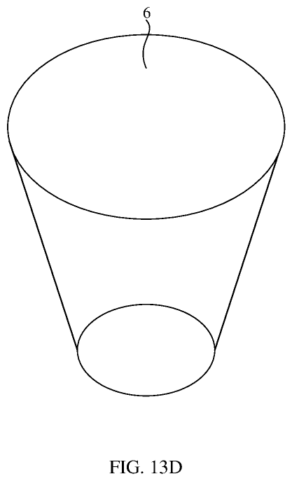

FIG. 12 shows a schematic diagram of a two-dimensional distribution of an optical structure of a light source module according to some exemplary embodiments of the present disclosure. FIG. 13A to FIG. 13D respectively show schematic diagrams of appearance of the optical structure in a case of the two-dimensional distribution shown in FIG. 12.

For example, in the embodiments of the present disclosure, orthographic projections of the plurality of optical structures 6 on the optical control layer 1 may be two-dimensionally distributed, that is, arranged at intervals in the first direction D1 and the third direction D3.

For example, referring to FIG. 13A, the optical structure 6 may have a shape of a prism. Referring to FIG. 13B, the optical structure 6 may have a shape of a pyramid. Referring to FIG. 13C, the optical structure 6 may have a shape of a truncated pyramid. Referring to FIG. 13D, the optical structure 6 may have a shape of a truncated cone.

In a case that the optical structures are two-dimensionally distributed, a distance between two adjacent optical structures 6 in the first direction D1 is a first pitch of the optical structures 6, denoted by P1; a distance between two adjacent optical structures 6 in the third direction D3 is a second pitch of the optical structures 6, denoted by P2.

Referring to FIG. 1 to FIG. 13D in combination, the light source module 100 may include at least two distribution areas, one is arranged close to the light incident surface 24, and the other is arranged away from the light incident surface 24. The depth of the optical structure 6 located in the distribution area close to the light incident surface 24 may be less than that of the optical structure 6 located in the distribution area away from the light incident surface 24, and/or the first pitch P1 of the optical structures 6 located in the distribution area close to the light incident surface 24 may be greater than that of the optical structure 6 located in the distribution area away from the light incident surface 24, and/or the second pitch P2 of the optical structures 6 located in the distribution area close to the light incident surface 24 may be greater than that of the optical structure 6 located in the distribution area away from the light incident surface 24.

For example, as shown in FIG. 12, an orthographic projection of the optical structure 6 located in the first distribution area DA1 on the light guide structure 2 may be a rectangle, an orthographic projection of the optical structure 6 located in the second distribution area DA2 on the light guide structure 2 may be a rectangle, and an orthographic projection of the optical structure 6 located in the third distribution area DA3 on the light guide structure 2 may be a rectangle.

The orthographic projection of each optical structure 6 located in the first distribution area DA1 on the light guide structure 2 may have an area less than that of the orthographic projection of each optical structure 6 located in the third distribution area DA3 on the light guide structure 2, and the orthographic projection of each optical structure 6 located in the third distribution area DA3 on the light guide structure 2 may have an area less than that of the orthographic projection of each optical structure 6 located in the second distribution area DA2 on the light guide structure 2.

In the embodiments of the present disclosure, through the refractive index matching between the various film layers of the light source module and the adjustment of the optical structure, more light from the light source may be effectively irradiated onto the reflective display panel through the light guide plate, so that the display quality may be improved. In addition, with the design of the size (such as depth, pitch, etc.) of the optical structure, the brightness uniformity of the display module may be improved, so that the display quality may be further improved.

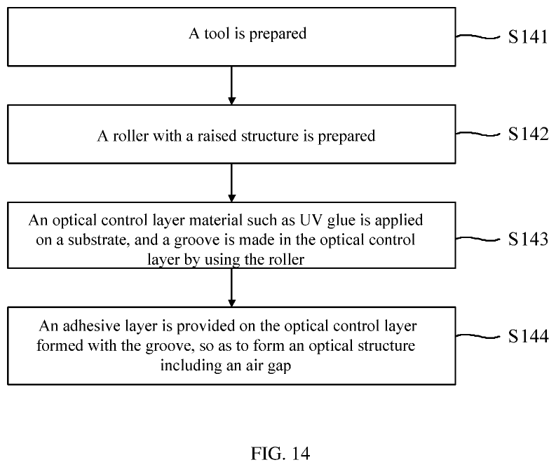

FIG. 14 shows a flowchart of a method of manufacturing a light source module according to some embodiments of the present disclosure. Referring to FIG. 1 to FIG. 14 in combination, a method of manufacturing the light source module includes steps of manufacturing the optical structure, for example, which may be performed as follows.

In step S141, a tool is prepared. The tool has a shape same as that of the optical structure to be formed, for example, the tool may have a triangular cross section.

In step S142, a roller with a raised structure is prepared. For example, the roller may be prepared by using the tool. The raised structure of the roller has a shape same as that of the optical structure to be formed, for example, the raised structure of the roller may have a triangular cross section.

In step S143, an optical control layer material such as UV glue is applied on a substrate, and a groove is made in the optical control layer by using the roller. The groove has a shape same as that of the optical structure to be formed, for example, the groove may have a triangular cross section.

In step S144, an adhesive layer is provided on the optical control layer formed with the groove, so as to form an optical structure including an air gap.

In the embodiments of the present disclosure, various optical structures may be prepared by using the same roller, which is beneficial to simplify the process and save the manufacturing cost. In addition, various optical structures with different depths may be formed by adjusting the processing depth using one roller.

Optionally, the embodiments of the present disclosure further provide a display device that may include the display module described above. The display device may include but not be limited to any product or component with a display function, such as electronic paper, mobile phone, tablet computer, television, display, notebook computer, digital photo frame, navigator, etc. It should be understood that the display device has the same beneficial effects as the display module provided in the foregoing embodiments.

Although some embodiments according to the general concept of the present disclosure have been illustrated and described, it should be understood by those ordinary skilled in the art that these embodiments may be changed without departing from the principle and spirit of the general concept of the present disclosure. The scope of the present disclosure is defined by the claims and their equivalents.

1. A light source module, comprising:
a light source;
a light guide structure comprising a light incident surface and a first surface, wherein a light emitted by the light source enters the light guide structure through the light incident surface;
an optical control layer arranged on the first surface of the light guide structure, wherein the optical control layer comprises an optical control layer body, and the optical control layer comprises a first surface away from the light guide structure and a second surface facing the light guide structure; and
at least two optical structures arranged in the optical control layer and configured to adjust a light incident on the optical structures,
wherein the plurality of optical structures are arranged at intervals at least in a first direction perpendicular to the light incident surface;
wherein each optical structure comprises a groove located in the optical control layer, and the groove forms an opening in the first surface of the optical control layer;
wherein each optical structure comprises a first optical surface and a second optical surface, the first optical surface and the second optical surface are spaced apart from the second surface of the optical control layer, the first optical surface is arranged closer to the light incident surface than the second optical surface, the first optical surface is inclined with respect to the first surface of the optical control layer, the second optical surface is inclined with respect to the first surface of the optical control layer, and the first optical surface and the second optical surface are arranged gradually closer to each other in a direction toward the light guide structure; and
wherein the groove is filled with a low refractive index material portion having a refractive index less than that of the optical control layer body; or the groove is filled with air, and the refractive index of the optical control layer body is greater than that of air.

2. The light source module of claim 1, wherein each optical structure comprises a first included angle formed between the first optical surface and a surface where the first surface of the optical control layer is located and a second included angle formed between the first optical surface and the second optical surface, and the first included angle and the second included angle are designed such that at least a part of the light emitted from the light source propagates toward the light guide structure.

3. The light source module of claim 1, wherein the refractive index of the light guide structure is substantially equal to that of the optical control layer body.

4. The light source module of claim 1, wherein an orthographic projection of each optical structure on a plane defined by the first direction and a second direction perpendicular to the first surface of the optical control layer is a triangle.

5. The light source module of claim 1, wherein the light source module comprises at least a first distribution area and a second distribution area, and the first distribution area is closer to the light incident surface than the second distribution area;
wherein each optical structure has a depth equal to a size of the each optical structure in the second direction; and
wherein an optical structure located in the first distribution area has a depth less than that of an optical structure located in the second distribution area.

6. The light source module of claim 1, wherein the light source module comprises at least a first distribution area and a second distribution area, and the first distribution area is closer to the light incident surface than the second distribution area;
wherein the optical structures have a first pitch equal to a distance between two adjacent optical structures in the first direction; and
wherein the optical structures located in the first distribution area have a first pitch greater than that of the optical structures located in the second distribution area.

7. The light source module of claim 2, wherein the first included angle ranges from 40° to 50°, and/or the second included angle ranges from 48° to 58°.

8. The light source module of claim 1, wherein the plurality of optical structures are arranged at intervals at least in a third direction, the second direction is perpendicular to the first surface of the optical control layer, and the third direction is perpendicular to the first direction and the second direction.

9. The light source module of claim 8, wherein the optical structures have a second pitch equal to a distance between two adjacent optical structures in the third direction; and
wherein the optical structures located in the first distribution area have a second pitch greater than that of the optical structures located in the second distribution area.

10. The light source module of claim 1, further comprising:
a protection structure arranged on a side of the optical control layer away from the light guide structure; and
an adhesive arranged between the optical control layer and the protection structure,
wherein an orthographic projection of the adhesive on the light guide structure
covers orthographic projections of the plurality of optical structures on the light guide structure.

11. The light source module of claim 10, wherein a refractive index of the protection structure, a refractive index of the adhesive and a refractive index of the optical control layer body are substantially equal to each other.

12. The light source module of claim 6, further comprising a third distribution area arranged between the first distribution area and the second distribution area;
wherein the optical structure located in the first distribution area has a depth less than that of the optical structure located in the third distribution area, and the depth of the optical structure located in the third distribution area is less than that of the optical structure located in the second distribution area; and/or
the optical structures located in the first distribution area have a first pitch greater than that of the optical structures located in the third distribution area, and the first pitch of the optical structures located in the third distribution area is greater than that of the optical structures located in the second distribution area.

13. The light source module of claim 11, wherein the refractive index of the light control layer body ranges from 1.55 to 1.65.

14. The light source module of claim 8, wherein each optical structure has a shape selected from a prism, a pyramid, a truncated pyramid, and a circular truncated cone.

15. A display module, comprising the light source module of claim 1.

16. The display module of claim 15, further comprising a display panel arranged on a side of the light guide structure away from the optical control layer, wherein the display panel is a reflective display panel.

17. A method of manufacturing a light source module, at least comprising:
preparing a roller with a raised structure, wherein the raised structure of the roller has a shape same as that of an optical structure to be formed;
applying an optical control layer material on a substrate, and making a groove in the optical control layer by using the roller, wherein the groove has a shape same as that of the optical structure to be formed; and
providing an adhesive layer on the optical control layer formed with the groove, so as to form an optical structure,
wherein the optical structure comprises the groove located in the optical control layer and a low refractive index material portion filled in the groove, the optical control layer comprises an optical control layer body, and the low refractive index material portion has a refractive index less than that of the optical control layer body;
wherein the optical control layer comprises a first surface and a second surface, and the groove is formed in the first surface; and
wherein the optical structure comprises a first optical surface inclined with respect to the first surface and a second optical surface inclined with respect to the first surface, and the first optical surface and the second optical surface are arranged gradually closer to each other in a direction toward the second surface.
